(19) United States
(12) Patent Application Publication
(10) Pub. No.: US 2004/0181807 A1
(43) Pub. Date: Sep. 16, 2004

(54) System and method for scheduling digital cinema content

(76) Inventors: Christopher H. Theiste, Plymouth, MN (US); Joseph Agee, Richfield, MN (US); Thomas J. Schmidt, Highlands Ranch, CO (US)

Correspondence Address: Stuart T. Langley, Esq., Hogan & Hartson, LLP, Suite 1500, 1200 17th Street, Denver, CO, 80202, US

(21) Appl. No.: 10/458,034

(22) Filed: Jun. 10, 2003

Related U.S. Application Data
(63) Continuation of application No. 10/386,366, filed on Mar. 11, 2003.

(51) Int. Cl. H04N 7/18; H04N 7/16

(52) U.S. Cl. 725/82; 725/74; 725/146

(57) ABSTRACT

A method of scheduling digital content presentations in a theatre by providing content items in a theatre server. A plurality of scheduling records are stored at the theatre server, where each scheduling record identifies at least one content item. The scheduling records include scheduling data associated with that particular content item, wherein the scheduling data includes at least one item of information that correlates to a particular presentation criterion that must be satisfied when the content item is presented. Optionally, theatre schedule information indicates particular events, other than the digital content presentation, that will be presented in particular auditoriums and includes the scheduling information including at least one attribute of the feature presentation. A play list is built for a particular auditorium by selecting scheduling records that will have their presentation criteria satisfied by the at least one attribute specified in the theatre schedule information arranging content items associated with each of the selected scheduling records to form the digital content show play list.

### RELATED APPLICATIONS

The present invention is a continuation of U.S. patent application Ser. No. 10/386,366 entitled SYSTEM AND METHOD FOR SCHEDULING IN-THEATRE ADVERTISING which was filed on Mar. 11, 2003, which is incorporated herein by reference.

### BACKGROUND OF THE INVENTION

1. Field of the Invention

The present invention relates, in general, to systems and methods for displaying digitally delivered content such as movies, advertising, live events, news, conferences, and the like, and, more particularly, to software, systems and methods for scheduling presentation of digital content.

2. Relevant Background

Digital cinema is a term that refers generally to systems and methods for distributing and presenting motion picture “films” electronically to theatres. While movie distribution has been a focus of digital cinema, the techniques and systems involved in presenting digitally formatted content extend beyond motion pictures.

Almost every type of event, including live, delayed, and recorded events, can be distributed and presented using digital cinema techniques.

Movie theatres continue to be a popular venue for presenting various forms of entertaining, educational, and business-related multimedia content. One of the biggest advantages of the theatre environment is a unique setting where patrons are predisposed to attentively receive multimedia presentations. Unlike television, billboards and newspapers, a movie theatre is an environment where the audience intends to listen, watch, and be receptive to what is presented. Each theatre holds a relatively small audience, but this offers opportunities to more specifically target the presented content to the needs of that audience. While movies appeal to a variety of demographics, the theatre audience at any particular showing has certain inherent characteristics in common. These common characteristics are what brought the people together in the theatre such as interest in a particular movie, genre, or rating. Also, the audience at any given showing have some geographic similarity, and often similar work and free time schedules.

Because of the ease and efficiency with which digital content can be created, stored, distributed and presented, digital cinema systems offer an opportunity to use the established network of theatres for a variety of other types of presentations. Moreover, digital cinema offers the opportunity to mix content in unique ways that were not possible with conventional moving pictures. For example, digital cinema techniques can mix live content from multiple locations and/or mix live content with recorded content to create uniquely effective presentations for a variety of purposes.

Conventional theatres, however, have limited resources for scheduling and presenting content items from various sources. Because conventional theatre operations are designed to present a single film, sometimes in conjunction with digital content show advertising, they have not had a need for more sophisticated scheduling techniques. Examples of in-theatre presentations include a pre-feature slide show that displays a repeating loop of advertising slides, often interspersed with entertainment slides. The loop is started at some arbitrary time between shows and repeats until the upcoming feature begins. The loop repeats while the audience is seated such that an ad may appear several times before the feature presentation begins. Optionally, the feature presentation is preceded by trailers advertising other films, where the trailers are physically spliced to the feature film.

More recently, “rolling stock” advertisements have become available in which a short animated feature, film, or other moving-picture feature is presented. Usually, the rolling stock is physically spliced to the beginning of a 35 mm feature film. As a result, there is no flexibility to alter when the rolling stock appears relative to the film, the rolling stock advertisement cannot be repeated during the digital content show as can slides, and the rolling stock will only appear immediately before the feature presentation. Moreover, rolling stock is not well suited to present the wide variety of alternative content that is available. A need exists for systems and methods that enable digital content presentation that has an impact comparable to rolling stock with the flexibility of slide programs, while offering a level of control and scheduling that is not currently available.

Hence, conventional theatre facilities and management systems have little ability to precisely determine, in advance, when particular content items will be presented. As a result, many of the advantages possible with digital cinema cannot be achieved without significant improvements in the way in which theatres schedule content for display. For example, even though digital cinema techniques allow a presentation to be compiled from multiple sources very quickly, existing theatre operations cannot direct how the multiple sources are to be combined. As a result, existing efforts towards digital cinema follow a model of conventional film-based presentations by compiling a presentation well in advance.

It would also be desirable if digital cinema could be scheduled to more specifically target various audience characteristics. For example, it would be desirable to geographically tailor a nationwide business presentation or sales presentation to more specifically address each audience's needs. Conventional in-theatre systems fail to capture the value of being able to target the audience. Accordingly, it would be desirable to schedule digital cinema features in a way that targeted specific audience characteristics.

The ambiance of a theatre is what continues to draw audiences even though many other venues for watching movies exist. The ambience created by lighting, sound, seating, picture quality, and other factors contribute to a unique entertainment environment. The audience itself plays an important role in the ambience as the individuals who attend a given presentation affect each other. The controlled theatre environment is designed to put the audience in a receptive frame of mind and keep them in that frame of mind. However, current theatre systems fail to take full advantage of this environment because of the inability to schedule, coordinate and present digital content items. In essence, although the theatre environment is designed to present a carefully controlled production, current practices make little use of this capability with respect to digital cinema.

In view of the above, there is an acute need for a new digital cinema scheduling and distribution system that will overcome the above shortcomings of current in-theatre content scheduling practices.

### SUMMARY OF THE INVENTION

Briefly stated, the present invention involves a method of scheduling presentations in a theatre by providing content items in a theatre server. A plurality of scheduling records are stored at the theatre server, where each scheduling record identifies at least one digital content item. The scheduling records include scheduling data associated with that particular digital content item, wherein the scheduling data includes at least one item of information that correlates to a particular presentation criteria that must be satisfied when the content is presented. Theatre schedule information indicates particular feature presentations that will be presented in particular auditoriums and includes the scheduling information including at least one attribute of the feature presentation. A play list is built for a particular auditorium by selecting scheduling records that will have their presentation criteria satisfied by the at least one attribute specified in the theatre schedule information arranging content items associated with each of the selected scheduling records to form the digital content show play list.

In another respect, the present invention involves a movie theatre having a plurality of auditoriums and presentation mechanisms within each auditorium operable to present visual and/or audio features to an audience. This embodiment of the invention includes a system for presenting a plurality of “digital content shows” alone or in conjunction with feature presentations, where each digital content show is specified for a particular auditorium and each digital content show comprises a sequence of digital content items (e.g., media files). In a specific instance, the system for presenting includes a play list data structure for each digital content show, the play list data structure defining the sequence of media files that make up the digital content show, media player components coupled to the presentation mechanisms and operable to play the sequence of media files defined by the play list, update services executing in the system for presenting and operable to detect changes that impact any one of the play lists, and a play list generator operable to create a replacement play list data structure in response to identifying a play list that is impacted by a change.

### BRIEF DESCRIPTION OF THE DRAWING

FIG. 1 shows a networked theatre environment in which the present invention is implemented;

FIG. 2 shows an exemplary theatre implemented in accordance with the present invention in functional block-diagram form;

FIG. 3 illustrates in functional block-diagram form auditorium components of a theatre system in accordance with the present invention;

FIG. 4 shows an exemplary theatre server components in accordance with the present invention in functional block-diagram form;

FIG. 5 shows data center components in accordance with the present invention;

FIG. 6 illustrates an exemplary scheduling architecture in accordance with a particular implementation of the present invention;

FIG. 7 shows an exemplary scheduling record in accordance with the present invention;

FIG. 8 illustrates an exemplary theatre schedule database in accordance with the present invention;

FIG. 9 shows an exemplary scheduling grid data structure used in a particular embodiment of the present invention; and

FIG. 10 shows an exemplary “queue table” data structure used in a particular embodiment of the present invention.

### DETAILED DESCRIPTION OF THE PREFERRED EMBODIMENTS

The present invention is illustrated and described in terms of a distributed theatre environment such as might be implemented by a national chain of theatres or an organization of cooperating independent theatre owners. However, the present invention is readily scaled to provide both international and local services, and may be implemented in a single venue. It should be understood that while the exemplary implementations involve presentation of digital content shows in conjunction with a main feature, the present invention is broadly applicable to scheduling digital content shows at any time before, during, and after a main feature or live event as well as scheduling digital content shows that will be presented alone (i.e., not in conjunction with a main feature or live event). Moreover, while the examples primarily involve theatre environments, it is contemplated that other entertainment venues and types may benefit from the present invention.

It is contemplated that the present invention will find applicability in many events that consist of or comprise the presentation of digital media or multimedia content. An “event” is construed broadly to mean live performances, live broadcasts or transmissions, as well as performances and transmissions of pre-recorded events. An event may take a single moment in time, or span a period of time. An event may itself comprise a continuous or discontinuous sequence of events. For example, live, broadcast, and multicast events such as concerts, sporting events, plays, speeches and the like may beneficially employ features of the present invention. Further, the present invention may be used to include pre-recorded features before, during, or after a primary feature presentation.

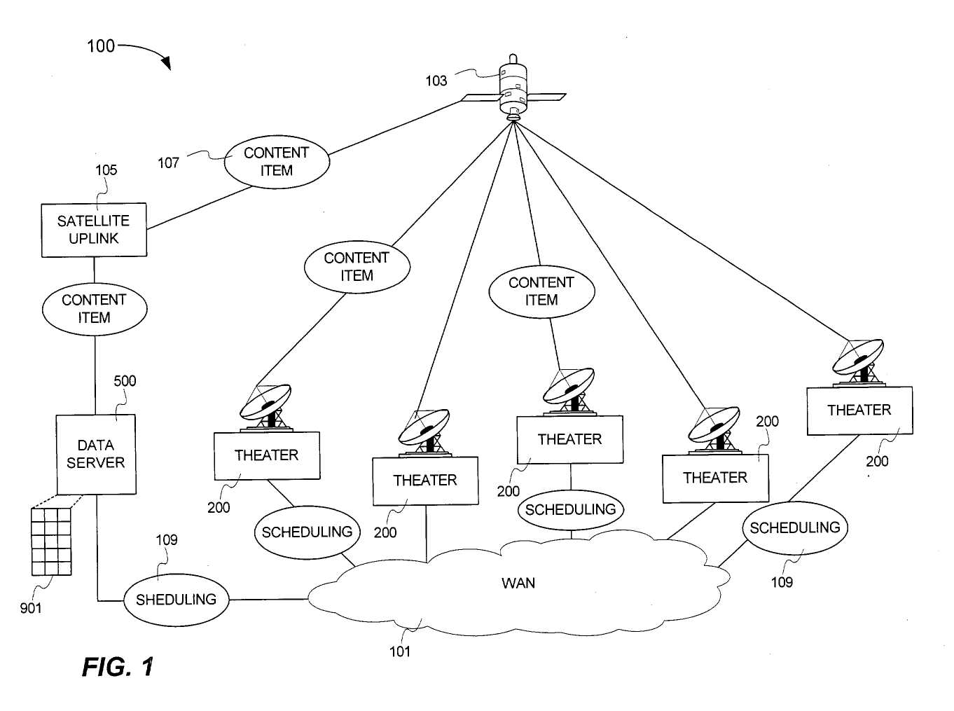

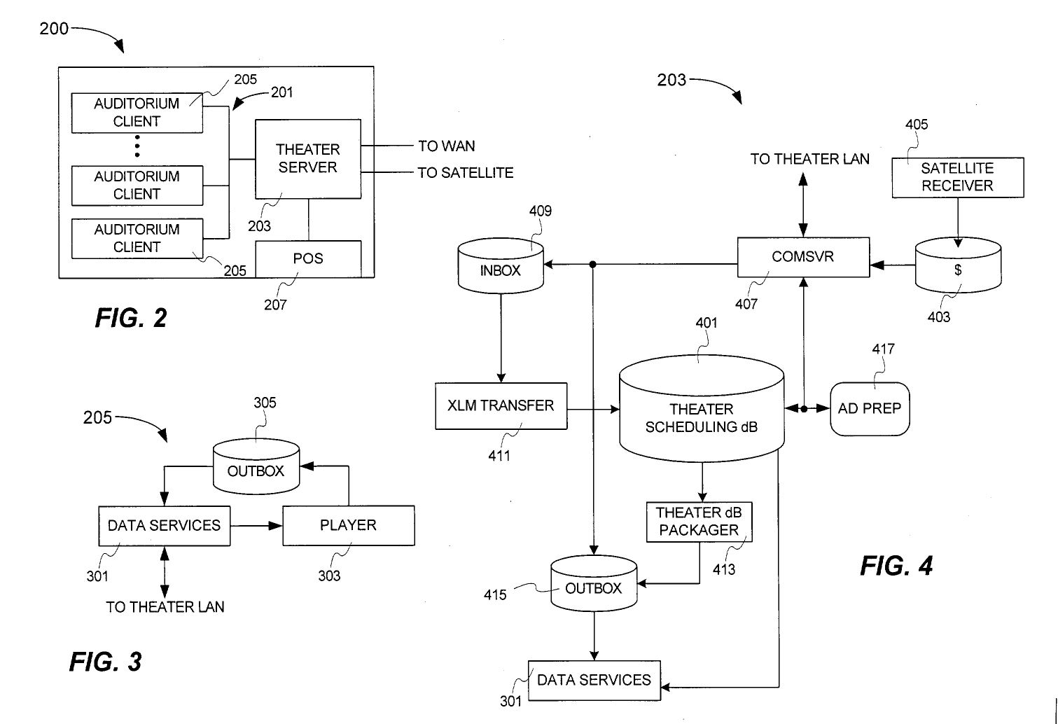

FIG. 1 shows an exemplary theatre environment 100 in which the present invention may be implemented. Environment 100 includes a plurality of theatre facilities 200, described in reference to FIG. 2, that are coupled to a data communication network such as wide area network (WAN) 101. Theatre facilities 200 may be distributed over any geographic area including regionally, nationally, or world-wide. A significant advantage of the present invention is that it enables coordinated distribution of digital content items to geographically and demographically diverse audiences. Because features of the present invention enable targeting to be improved over this diverse group of theatres 200, the market for digital cinema services and facilities is larger than with conventional regional-based in-theatre advertising systems. Also, because digital cinema services may provide a wide variety of content sources, including live segments, pre-recorded segments, audience targeted segments, and the like, the digital cinema system in accordance with the present invention can support a much broader range of applications that just movies and advertising now presented using film-based technologies. Moreover, because digital content items and digital content shows will reach a larger audience, content producers can justify greater expense to produce digital content items, making the entire experience more enjoyable.

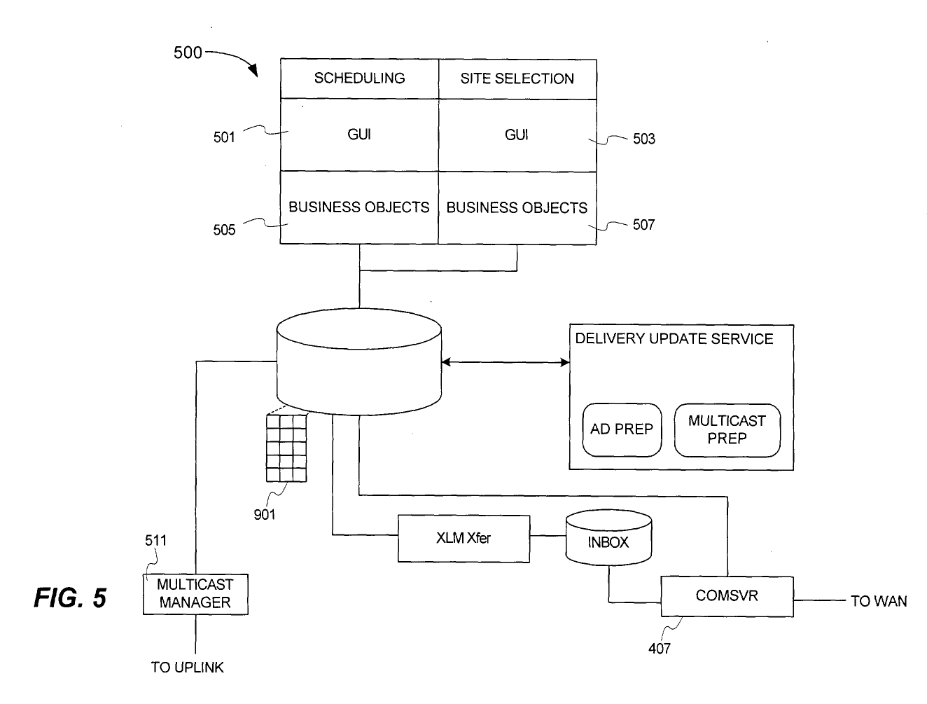

Environment 100 also includes one or more shared resources such as data server 500, described in greater detail in reference to FIG. 5. Data server 500 implements services to distribute content items 107, such as advertisements, training material, live entertainment, recorded entertainment, seminar presentation, and the like, to appropriate theatres 200. Data server 500 also implements services to distribute scheduling information 109 that can be used by theatres 200 to create and present appropriate presentations such as digital content shows. In a particular example, data server 500 maintains a “schedule grid” 900 that contains inventory information on a per-auditorium basis where the inventory information is the collection of presentation slots of various characteristics that can be or have been sold.

WAN 101 may be implemented by any available networking technology and protocols including private networks and public networks such as the Internet, although in either case appropriate security and authentication protocols may be desirable to prevent unauthorized system access. WAN 101 is primarily configured to support symmetrical or asymmetrical full duplex communication between theatres 200 and data server 500 to exchange scheduling information 109 used to schedule presentation of content items, and to report back on the status of scheduled content items to verify their presentation. However, WAN 101 may also be used to distribute the content items 107 themselves in some circumstances.

Because content items 107 tend to be larger multimedia files, in the particular implementation of FIG. 1 environment 100 includes a high bandwidth broadcast/multicast communication link implemented, for example, by a digital broadcast satellite (DBS) 103 through satellite uplink 105. Satellite 103 may be a private system, or may be provided by a contact satellite operator such as Hughes Network Systems of Germantown Maryland. In the particular example, content items 107 comprise media files that, when played, range in length from a few seconds up to several hours of material. The present invention is essentially transparent to the choice of encoding and compression mechanisms in that it is readily adaptable to any available encoding format and compression technique including proprietary mechanisms and industry standard formats such as MPEG-1, MPEG-2 and other MPEG standards that are available, “avi” files (audio video interleaved), “wav”(windows audio video), Windows Media audio and video files (identified by various file extensions such as .asf, .asx, wax, .wm, .wma, .wmd, .wmp, .wmv, .wmx, .wpl, and .wvx), Macromedia flash (identified by “.swf” extensions), for example. Various file types, including raw data file types, may be used so long as appropriate encoding and decoding mechanisms are available to the system.

Hence, content files 107 may vary in size from a few thousand bytes to hundreds of gigabytes or more when encoded using industry standard formats. Content files 107 may also comprise still images and/or audio files that are considerably smaller. Accordingly, the high bandwidth broadcast/multicast solution shown in FIG. 1 may be modified as needed, or eliminated in some cases, to meet the needs of distribution content items 107 used in a particular application. Suitable alternatives include terrestrial cable and microwave transmission and other data communication technologies. Other alternatives include physical disk based transport techniques such as digital video disk (DVD), high definition DVD (HD-DVD), various compact disk formats, portable drives, and the like.

In operation, content scheduling information 109 is distributed to specific theatres 200 that will use that scheduling information. For example, if a content item 107 is to be used only in theatres in New York City, scheduling information 109 associated with that content item 107 will be communicated only to theatres 200 that are in New York City. Scheduling information may be selectively communicated based on a variety of factors including geography, theatre size, number of auditoriums in the theatre 200, audience demographics, attendance rates, theatre sales volume, and the like as determined by the content provider's desires.

In a particular implementation, content items 107 are distributed using a full multicast to all theatres 200 irrespective of whether each theatre 200 will have use for the particular content item 107. Full multicast is efficient in implementations in which digital broadcast satellite is used because a single transmission reaches all theatres 200 at the same time. By transferring all content items 107 to all theatres 200 the need for re-transmission of any content item 107 is reduced or eliminated. Full multicast is particularly convenient in that content items 107 can be transferred in advance of scheduling information, enabling the scheduling system to remain completely flexible up until nearly the instant that a particular content item 107 is presented. Theatres 200 can then implement processes to selectively remove content items 200 that are not needed. Alternatively, content items 107 may be distributed by unicast and/or targeted multicast only to theatres 200 that will have use for the particular item. This selective distribution may conserve storage and processing resources at each of theatres 200 and therefore have advantages in some applications.

An important feature of the preferred implementations involves the separation of activities involved in managing content items 107 and activities involved in managing and communicating scheduling information 109. Prior systems of scheduling content display often resemble television broadcast systems in that they organize and arrange content at a central system and stream that content out to distributed presentation systems. In such systems, digital content could be cached or stored at various locations to simplify distribution, but the order and arrangement of the content items within a stream were fixed before the presentation. In many cases, the content would not be downloaded until after the schedule for that content's presentation was fixed.

In contrast, the present invention contemplates a system that distributes content items 107 asynchronously to the presentation system (e.g., a theatre or auditorium within a theatre). In many cases, the schedule information 109 is supplied to the presentation system after the content items 107 referred to by the schedule information 109 have been delivered. This enables the present invention to determine order and arrangement of content items 107 entirely independently of content distribution. In this manner, the presentation order and arrangement can be defined dynamically in the minutes or moments preceding the presentation of the content items. Because schedule information 109 will typically be much smaller than content items 107, the schedule information 109 can be communicated to the distributed presentation systems just in time for a presentation thereby ensuring the most current content items 107 and schedule information 109 are used.

The present invention contemplates both a push system in which content items 107 are pushed to particular theatres 200 or groups of theatres 200 that will use the content items, or by a pull a system in which theatres 200 request content items 107 that they will need. With respect to content items 107, delivery is primarily a push system so that content items 107 are distributed in advance of schedule information 109. In an exemplary push system, data server 500 initiates transfers of content items 107 to all or targeted auditorium clients 205 (shown in FIG. 2) within theatres 200. In an exemplary pull system, data server 500 generates but sends content items 107 to the appropriate theatre 200 in response to a specific request from an auditorium client 205. It is further contemplated that hybrid push-pull systems will be useful in many instances. For example, in a push system, theatre servers 203 and/or auditorium clients 205 may initiate a content pull if they discover that scheduled content items 109 have not yet been delivered by the push mechanisms.

Similarly, the present invention contemplates that scheduling information 109 (and commands related to scheduling) can be distributed by push or pull methods to theatres 200. In an exemplary push system, data server 500 initiates transfers of scheduling information 109 to appropriate auditorium clients 205 (shown in FIG. 2) within theatres 200. hn an exemplary pull system, data server 500 generates scheduling information 109, but sends it to the appropriate theatre 200 in response to a specific request from an auditorium client 205.

FIG. 2, FIG. 3 and FIG. 4 together illustrate various data processing and storage components implemented in theatre facilities 200 in a specific implementation. The push and pull systems introduced above are implemented in particular examples with substantially similar data structures, although the precise implementation of data structures may be varied significantly from the specific examples given herein. As shown in FIG. 2, most theatres 200 comprise a theatre server 203 and a plurality of auditorium clients 205 coupled together by a theatre network 201. Theatre network 201 may comprise, for example, an available local area network (LAN) such as Ethernet, fibre channel, IP networks and the like having data transfer rates suitable to meet the needs of a particular application. Theatre server 203 implements communication interfaces with satellite 103 and WAN 101 shown in FIG. 1.

Theatre server 203 implements processes and data structures that are used to schedule and coordinate presentation of sequences of content items 107 in the form of, for example, digital content show presentations. Theatre server 203 receives scheduling information 109, requests and receives content items 107 and implements caches for temporary local storage of content items 107 and scheduling information 109.

A theatre 200 comprises one or more auditoriums. An auditorium is the room in which a film or feature is presented, and many theatres have one to perhaps twenty or thirty auditoriums. Each auditorium client 205 corresponds to a set of software processes that coordinate the presentation of content items 107 in a particular auditorium. Each auditorium will include projection equipment and audio equipment suitable for presenting a feature presentation (e.g., a film) and for presenting the content items 107 (e.g., in the form of a digital content show presentation). The projection and audio equipment may be the same for both types of presentations, although in current implementations the feature presentation equipment comprises conventional 35 mm projection equipment while the digital content show presentation equipment comprises digital projectors and digital audio equipment. Auditorium clients 205 may include interfaces for automating the projection/audio equipment, or the projection/audio equipment may rely on human operators.

FIG. 3 shows an embodiment of an auditorium client 205 in greater detail. Auditorium client 205 implements a connection to theatre LAN 201 and implements a data services instance 301 and one or more media player components 303. Data services component 301, an instance of which also appears in theatre server 203, comprises processes that handle communication with theatre server 203 through theatre LAN 201 and implement the communication protocols and resource allocation needed to support this communication. In a particular example, these communications use a proprietary protocol, although industry standard protocols and hybrid protocols may be appropriate in particular implementations. On the auditorium client 205, data services component 301 operates to access theatre scheduling database 401, shown in FIG. 4 and look up feature presentation times from a movie schedule record. Using this information, data services component 301 knows when to initiate a digital content show. For example, by determining that a movie is scheduled to start at 7:00 PM, data service component will initiate a playback of a sequence of content items 107 at a specified time such as 6:40 PM so that the sequence of content items 107 is presented as desired.

By way of a specific example, a “show” comprises a number of content items 107 that are presented in a particular order to create a show. In many cases, a show may include some content items 107 that are scheduled to be presented at a particular time, such as a feature presentation in a movie, a particular live or broadcast event, or the like. Other content items may have flexible start times that may be set just before presentation. The scheduling functions of the present invention operate to seamlessly coordinate and synchronize the presentation of the content items with flexible schedules along with one or more content items 107 that have specified schedules. Each client 205 receives a “boxtime file” that lists the show start time for content items 107 that have a specified start time that are scheduled at that auditorium for that day. Data services component 301 looks at the play list data structure and calculates the length of that play list (e.g., the amount of time required to present all content items 107 on the play list). Data services component 301 then uses this time and starts the player application in direct relation to the listed show start time. So if the calculated play list is 20 minutes long, and the next show time is at 8:00 pm, data services component 301 will start presenting the digital content show defined by the play list at 7:40 pm. It does this for every show time listed. In this manner, it can be ensured that the flexible-schedule content items 107 will be presented and that their presentation will end in synchronization with the start of the presentation of a fixed-schedule content item 107.

Optionally, processes are included, for example in data service component 301, to generate one or more notifications to a projectionist or to an automated projection system regarding the start time of a feature presentation. Currently, a feature presentation is provided on film and the film projector needs to be started in synchronization with the end of a digital content show. A human projectionist may be alerted by particular tones, blinking lights, a countdown timer, email notification and/or pager notifications. In a particular example a first notification is provided at 3 minutes before the feature presentation and a second notification is generated when the feature presentation is scheduled to start. This ensures the projectionist will be prepared after the break between shows. When automated projection equipment is involved, the notification can be made to the automated system to warm up the projector, start the projector or perform other theatre operations such as adjusting lighting, sound, curtains, screen level, and the like.

Player component 303 operates on the data items to drive the projection and audio equipment in a substantially conventional manner. Optionally, data services component 301 may be outfitted with processes to automatically control the projection and audio equipment. To implement a schedule-pull system, data services component 301 will include processes for polling theatre server 203 and/or data server 500 as needed to determine if there is any new scheduling information 109 that should replace the currently active scheduling information 109. Upon determination that new scheduling information 109 exists, a transfer of that new scheduling information is initiated. A particular client 205 may hold multiple play lists 600, but only one play list 600 is active at any given time. In a schedule push implementation, scheduling information is pushed to client 205 such that polling processes are not required.

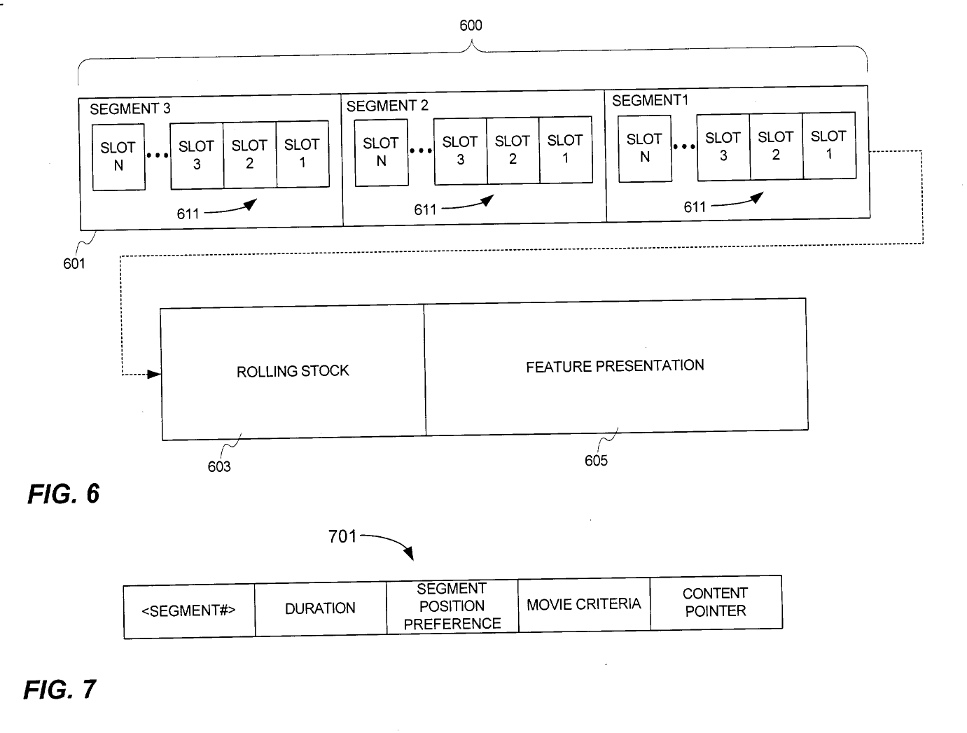

The sequence of content items 107 that is to be played by any particular auditorium client 205 is defined by a play list represented by a play list data structure 600 described in reference to FIG. 6. A play list 600 is generated by theatre server 203 and/or data server 500 from the inventory information contained in schedule grid 900 (shown in FIG. 1 and FIG. 9). A play list 600 is specific to a particular auditorium client 205, although it is contemplated that two or more auditorium clients 205 may have similar play list 600. Play list 600 is communicated to data services component 301 in addition to the information about movie start time. In a particular example, data services component 301 implements a cache structure (not shown) for holding a copy of the content items 107 that will be included in a particular sequence being presented. Alternatively, data services component 301 may be used to pull cached content items 107 from storage within theatre server 203.

In a particular example, outbox 305 is used to store messages indicating summary information about the status of the presentation of data items 107. As a data item is played, a message (e.g., an XML document) is created to indicate information such as the time at which the data item 107 played, the auditorium in which it played, and the like. It is contemplated that any level of detail about the playback may be maintained in this manner. The playback message may contain information about the audience size, audience demographic information, or information indicating the feature presentation that is scheduled to be presented in conjunction with the data item 107. This record is transmitted through data services 301 to theatre server 203 and can be used to provide an auditable record of content item presentations. Some prior audit systems create a record each time a content item is decrypted for licensing purposes, but such records do not actually confirm that a particular content item has been presented. In contrast, the present invention allows a positive confirmation that a content item was actually presented.

FIG. 4 illustrates functional components of an exemplary theatre server 203 in greater detail. Theatre server 203 services all auditorium clients 205 in a given theatre facility 200. Content items 107 are received through satellite receiver interface 405 and stored locally in cache data store 403. A comsvr component 407 implements processes to support both push and pull functionality for accessing content items and populating cache 403 with content items 107. In the case of a content push system it is possible that many content items 107 will be delivered that have little or no use in a particular theatre server 203. Theatre server 203 implements processes, for example within comsvr component 407, that manage cache data store 403 using an appropriate algorithm such as least recently used (LRU), time in cache, first in first out, or the like.

In a particular implementation, comsvr component 407 checks for updated schedule information 109 that is ready to be sent to theatre server 203. This update service is used in two primary logical locations: at the data center 500 to push out updated schedule information 109, and in theatre server 301 to push updated content items 107 and play-lists 600 to the auditorium clients 205.

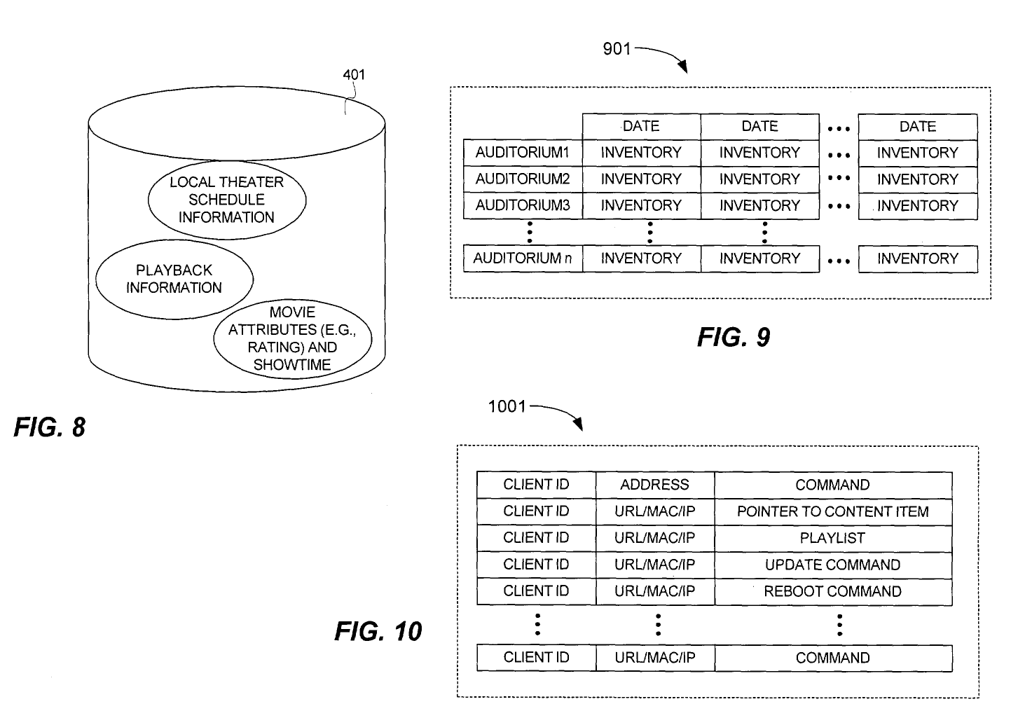

Theatre schedule database 401 is implemented, for example, by an MSDE (Microsoft data engine) database available from Microsoft Corporation. However, any available database engine may be used such as mySQL database server from mySQL AB, Oracle database produces from Oracle Corporation and the like. As shown in detail in FIG. 8, theatre schedule database 401 stores the local theatre 200 schedule information 109 as well as information regarding movie attributes and show times. Theatre schedule database 401 serves as a collection point for content item playback transaction data received through inbox 409 and XML transfer component 411. That is, theatre schedule database 401 stores the XML records that hold information about which ads played in which auditoriums and when. The playback information is communicated through theatre database packager 413 and outbox 415 to data center 500 on a regular basis. Theatre database packager 413 operates to reformat and/or aggregate playback records to simplify communication and handling, if desired.

Data services component 301, which is substantially similar to that described in reference to FIG. 3, is used on theatre server 203 to handle the delivery of updated schedule data. Data services component 301 is adapted to connect to local theatre schedule database 401 and update it accordingly. Alternatively, this function may be handled by the Play List Prep service 417 (labeled “Ad Prep” in FIG. 4). Play List Prep service 417 comprises a set of processes that manage the play-list generation within the theatre facility 200 it is serving. Play List Prep service 417 reads a schedule grid 900 (shown in FIG. 1 and FIG. 9) to obtain inventory information for each auditorium client 205 in that theatre 200 and uses this information to determine what the play list 600 for each auditorium client 205 should look like and when it should be delivered.

Play List Prep service 417 then creates a “queue table” 1001 (shown in FIG. 10) which is essentially a command queue representing various scheduling information and other commands to be implemented in a particular client 205. Queue table 1001 includes a plurality of entries where each entry corresponds to a particular command to be implemented. Each entry identifies the auditorium client 205 and a network address of that auditorium client 205 (e.g., an IP address, MAC address, uniform resource locator or the like). Each entry includes some command/scheduling information such as a pointer to a content item 107, a play list 600 or pointer to a play list 600, or an op-code for a particular operation such as to activate a particular play list 600 or reboot the client 205.

In operation, entries in Q-table 1001 are distributed to the specified client 205 and executed by that client 205. Play List Prep service 417 creates the play list and queues up necessary content items 107 just before the play list 600 is supposed to start. This just-in-time system ensures that the latest scheduling information 109 is being used. For example, if a content provider has modified the content item(s) 107 that are intended to be presented, Play List Prep service 417 will note the change and ensure that the auditorium client 205 uses the updated content item 107 rather than stale content that might have been previously transferred. Further, the last minute generation of a play list 600 will contain a correct play list 600 even when last minute auditorium changes occur.

FIG. 5 illustrates functional components and processes implemented by data center 500 in a particular embodiment. A scheduling user interface 501 is configured to accommodate data display and entry for creating scheduling information 109. The scheduling information 109, includes an “presentation contract record” 701 that is shown in greater detail in FIG. 7. A site selection interface 503 is configured to accommodate data display and entry for allowing the specification of presentation requirements, presentation preferences, geographic preferences, or any other criteria recognized by the particular implementation. Scheduling records 701 are scheduled by placing them into inventory represented in scheduling grid 901. It is also contemplated that data center 500 may maintain a table that specifies contracts are considered ‘default’ contracts”. Default content items may identify entertainment items, general interest announcements, non-revenue content items that present information on how to purchase advertising space, general interest messages, instructional messages, safety messages, and the like. Default content items may be added to a play list 600 when there is unused inventory for a particular day at a particular client 205.

FIG. 6 illustrates an exemplary data structure for a play list 600. The present invention contemplates shows that comprise only digital content items 107, as well as shows that comprise a mix of digital content items 107 and other content such as a live presentation or film-based content. In the former case, the play list 600 may define the entire show. In the later case, play list 600 may define the digital content portions of a show. A play list 600 can be broken down into a number of different segments 601. Each segment 601 can be specified to be a different length and/or contain a different number of slots 611. In a particular implementation, each slot 611 represents 15 second time window and may point to at most a single content item 107. Within each segment 601 content items 107 can be weighted by specifications from the schedule record such that the content items 107 will tend to be placed in slots towards the beginning or end of a segment 601 depending on the desired result. For example an content provider may decide they want content items 107 to be in the third segment 601 of the play list 600, but they want to be the last content item played within that segment 601. When the show comprises non-digital content, play list 600 is followed by, for example a rolling stock presentation 603 and a feature presentation 605. Optionally, where theatre automation components are used, the play list 600 may specify the state of other controllable features of the theatre environment such as lighting levels, volume levels and the like.

FIG. 7 illustrates an exemplary content item schedule record that contains scheduling information 109 related to a particular content item 107. This information includes, for example, presentation requirements designated by the content provider such as a requirement that the associated data item be presented with a particular movie rating. This information also includes presentation preference information such in which segment of play list 600 the data item should appear and whether there is a preferred slot within the segment. Information about the duration of the data item which may be measured in terms of a number of slots consumed, is also included.

The processes involved in the present invention include sales and marketing processes enabled by the present invention. For example, when sales personnel meet with an customer who desires to present digital content at a theatre, the sales personnel determine requirements and preferences with respect to particular content item the content provider may specify geographic requirements, presentation requirements, or the like as described above. The sales personnel create a “customer proposal” using the processes referred to herein as a “Proposal Machine”. The proposal indicates, for example, the number of theatres 200 selected, pricing information, the length of the proposed engagement and the segment of the play list 600 they would like the digital content to appear in.

Once the client agrees to the proposal, the proposal is converted into a presentation contract 701. A scheduler then schedules the presentation contract into a schedule grid 901, following the proposal details of length of contract, sites selected, rate(s), position(s) in play list, as well as movie rating. Once scheduled, a play list 600 is generated and entries in Q-table 1001 are generated. Clients 205 then follow the directions from the Q-table 1001 to cause presentation of content items 107 according to the scheduled contracts.

The present invention allow presentation contracts to be written without “total” knowledge of the future. For example, it is possible to estimate the number of screens available for a particular content item requirement using average percentages of movies that are classified with each movie rating. From this estimate “virtual auditoriums” can be used as “place holders” for digital content shows with particular requirements or characteristics. The system can then schedule media buys (e.g., presentation contracts) to the place holder auditoriums, thereby selling this “virtual inventory” before it actually comes into existence, and tracking that inventory through the term of the contract. As specific films are scheduled in specific auditoriums, real inventory becomes available and the contracts can be reassigned to an appropriate auditorium. The system of the present invention is desirably able to reconcile this virtual inventory against the actual inventory that is created at show time.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

We claim:

1. A method of scheduling digital content show presentations in a theatre comprising:
providing digital content items in a theatre server;
storing a plurality of scheduling records at the theatre server, each scheduling record identifying a particular content item and including scheduling data associated with that particular content item, wherein the scheduling data includes at least one item of information that correlates to a particular presentation criteria that must be satisfied when the content is presented;
building a digital content show play list for a particular auditorium by:
selecting scheduling records that will have their presentation criteria satisfied by the at least one attribute specified in the theatre schedule information; and
arranging content items associated with each of the selected scheduling records to form the digital content show play list.

2. The method of claim 1 wherein the scheduling records further comprise information indicating preferred time criteria and the act of arranging content items uses the preferred time criteria to determine an order of content items in the play list.

3. The method of claim 1 wherein the act of providing content items comprises:
requesting at least one of the content items in digital form from a first digital communication network after selecting a contract record that identifies the at least one content item; and
storing the requested content items locally in the theatre server.

4. The method of claim 1 wherein the act of providing content items comprises:
receiving the content items in digital form from a first digital communication network before selecting a contract record that identifies the at least one content item; and
storing the requested content items locally in the theatre server.

5. The method of claim 1 wherein the digital content show play list is organized as a plurality of segments where each segment contains one or more slots and the act of arranging content items to form the play list comprises placing the content items into particular slots.

6. The method of claim 5 wherein the segments have a variable length.

7. A presentation contract record for use in presenting a digital content show, the contract record comprising:
identification of particular content item;
specification of at least one presentation criteria that must be satisfied when the content item is presented; and
specification of at least one presentation preference that is desirably satisfied when the content item is presented.

8. The presentation contract record of claim 7 wherein the presentation criteria comprises a geographic criteria.

9. The presentation contract record of claim 7 wherein the particular digital content item comprises an industry standard format media file.

10. A digital content show play list data structure comprising:
a plurality of segments;
one or more slots within each segment, each slot configured to identify at least a portion of a content item such that the digital content show play list defines a sequence of content items that will be presented in a particular order.

11. The digital content show play list of claim 10 wherein the segments have a variable length.

12. A method of building a play list defining a digital content show for digital cinema presentation, the method comprising the acts of:
obtaining scheduling records indicating presentation criteria for content items from a remote source;
obtaining auditorium scheduling information, the auditorium scheduling information including attributes of other events being presented within a particular auditorium;
building the digital content show play list in conjunction with one or more of the other events being presented by matching the presentation criteria with the attributes of the other events being presented to select a set of digital content items to be included in the digital content show play list.

13. The method of claim 12 further comprising the act of:
arranging the selected set of digital content items in an order within the play list that satisfies specified presentation preferences.

14. A digital cinema theatre comprising:
a plurality of auditoriums;
presentation mechanisms within each auditorium operable to present digital content to an audience;
a system for presenting a plurality of digital content shows before feature presentations, where each digital content show is specified for a particular auditorium and each digital content show comprises a sequence of media files, wherein the system for presenting comprises:
a digital content show play list data structure for each digital content show, the play list data structure defining the sequence of media files that make up the digital content show;
media player components coupled to the presentation mechanisms and operable to play the sequence of media files defined by the digital content show play list;
update services executing in the system for presenting and operable to detect changes that impact any one of the digital content show play lists; and
a play list generator operable to create a replacement digital content show data structure in response to identifying a digital content show play list that is impacted by a change.

15. The digital cinema theatre of claim 1 wherein the content items comprise a recorded media file.

16. The digital cinema theatre of claim 1 wherein the content items comprise a streaming media file.

17. A method for creating a show comprising a plurality of content items, the method comprising:
providing a set of contract records, each contract record being associated with a content item and specifying at least one presentation criterion; and
selecting content items so as to satisfy the presentation criterion; and
scheduling the selected content items for presentation in a sequence that forms the show.

18. The method of claim 17 further comprising creating a play list for the show by defining relative order in which the selected content items will be presented.

19. The method of claim 17 wherein the act of selecting is performed automatically.

20. The method of claim 17 wherein at least one content item is scheduled for presentation at a specific time, and the act of scheduling comprises scheduling the content items based in part on the at least one content item that is schedule for presentation at a particular time.

21. The method of claim 17 wherein the selecting and scheduling are preformed manually.
